(19) United States
(12) Patent Application Publication
(10) Pub. No.: US 2013/0199492 A1
(43) Pub. Date: Aug. 8, 2013

(54) INTERNAL COMBUSTION ENGINE UTILIZING DUAL COMPRESSION AND SINGLE EXPANSION PROCESS

(71) Applicants: Venkatesh Gopalakrishnan, Troy, MI (US); Russell P. Durrett, Bloomfield Hills, MI (US); Paul M. Najt, Bloomfield Hills, MI (US)

(72) Inventors: Venkatesh Gopalakrishnan, Troy, MI (US); Russell P. Durrett, Bloomfield Hills, MI (US); Paul M. Najt, Bloomfield Hills, MI (US)

(73) Assignee: GM GLOBAL TECHNOLOGY OPERATIONS LLC, Detroit, MI (US)

(21) Appl. No.: 13/368,400

(22) Filed: Feb. 8, 2012

(51) Int. Cl. F02B 75/02

(52) U.S. Cl. 123/254; 123/64; 123/41.01; 123/257

(57) ABSTRACT

An internal combustion engine includes a compressor cylinder having a respective inlet, a first outlet and a respective piston slideably movable within the compressor cylinder and operatively connected to a rotating crankshaft. The compressor cylinder provides a first stage of compression to a charge when the charge is transferred from the compressor cylinder during every revolution of the crankshaft. A first power cylinder includes a respective inlet in fluid communication with the first outlet of the compressor cylinder, a respective outlet and a respective piston slideably movable within the first power cylinder and operatively connected to the rotating crankshaft. The first power cylinder provides a second stage of compression and firing of the charge within the first power cylinder every two revolutions of the crankshaft.

### TECHNICAL FIELD

This disclosure is generally related to combustion engines.

### BACKGROUND

The statements in this section merely provide background information related to the present disclosure and may not constitute prior art.

Modern combustion engines generally include spark-ignition engines and compression-ignition engines. During operation, the efficiency of a combustion engine depends on many factors, including volumetric and thermodynamic efficiency.

It is known to employ engines with forced induction devices including turbo-chargers and super-chargers, which are predominantly add-ons to a basic engine design. While relatively easy to service, these devices can be problematic and are limited from several aspects inherent to their design.

### SUMMARY

An internal combustion engine includes a compressor cylinder having a respective inlet, a first outlet and a respective piston slideably movable within the compressor cylinder and operatively connected to a rotating crankshaft. The compressor cylinder provides a first stage of compression to a charge when the charge is transferred from the compressor cylinder during every revolution of the crankshaft. A first power cylinder includes a respective inlet in fluid communication with the first outlet of the compressor cylinder, a respective outlet and a respective piston slideably movable within the first power cylinder and operatively connected to the rotating crankshaft. The first power cylinder provides a second stage of compression and firing of the charge within the first power cylinder every two revolutions of the crankshaft.

### BRIEF DESCRIPTION OF THE DRAWINGS

One or more embodiments will now be described, by way of example, with reference to the accompanying drawings, in which:

FIG. 1 schematically illustrates an engine in accordance with the present disclosure;

FIG. 2 schematically illustrates an engine including heat exchanger devices and exhaust gas recirculation (EGR) systems in accordance with the present disclosure; and

FIGS. 3-7 illustrate motion and position of pistons and valves in an engine in accordance with the present disclosure.

### DETAILED DESCRIPTION

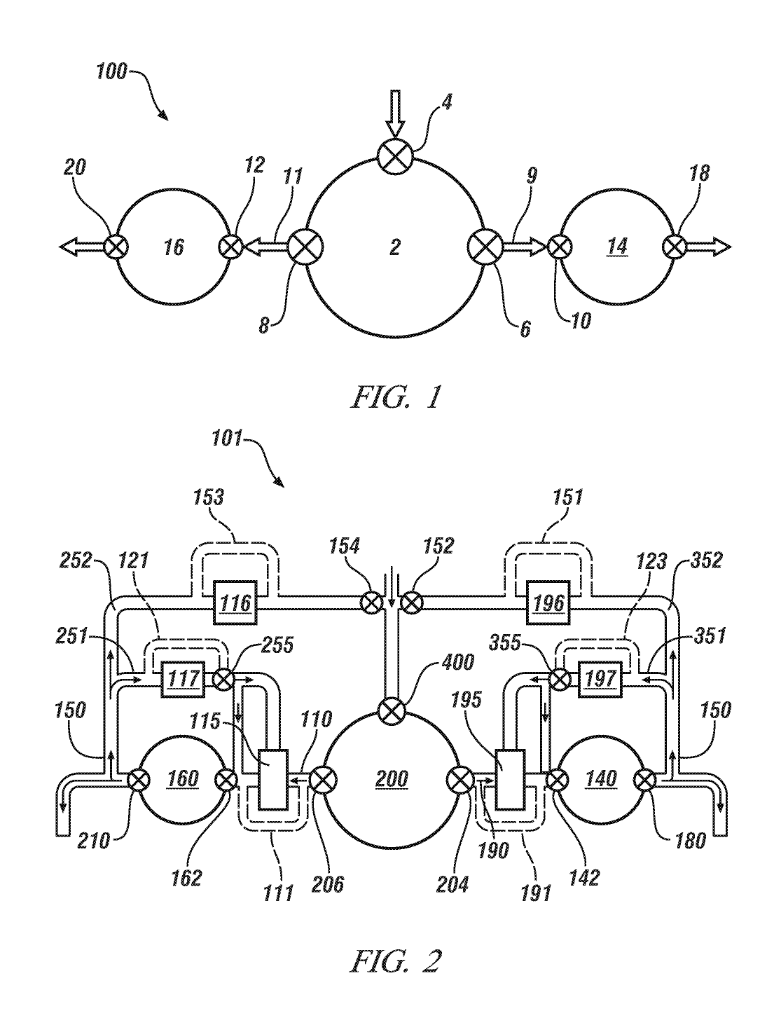

Referring now to the drawings, wherein the showings are for the purpose of illustrating certain exemplary embodiments only and not for the purpose of limiting the same, FIG. 1 illustrates a schematic representation of an engine 100 in accordance to the present disclosure. The present disclosure provides a three-cylinder internal combustion engine including a two-stroke compressor cylinder 2 and a pair of four-stroke power cylinders 14,16. The pair of power cylinders 14,16 can be referred to as a first power cylinder 14 and a second power cylinder 16.

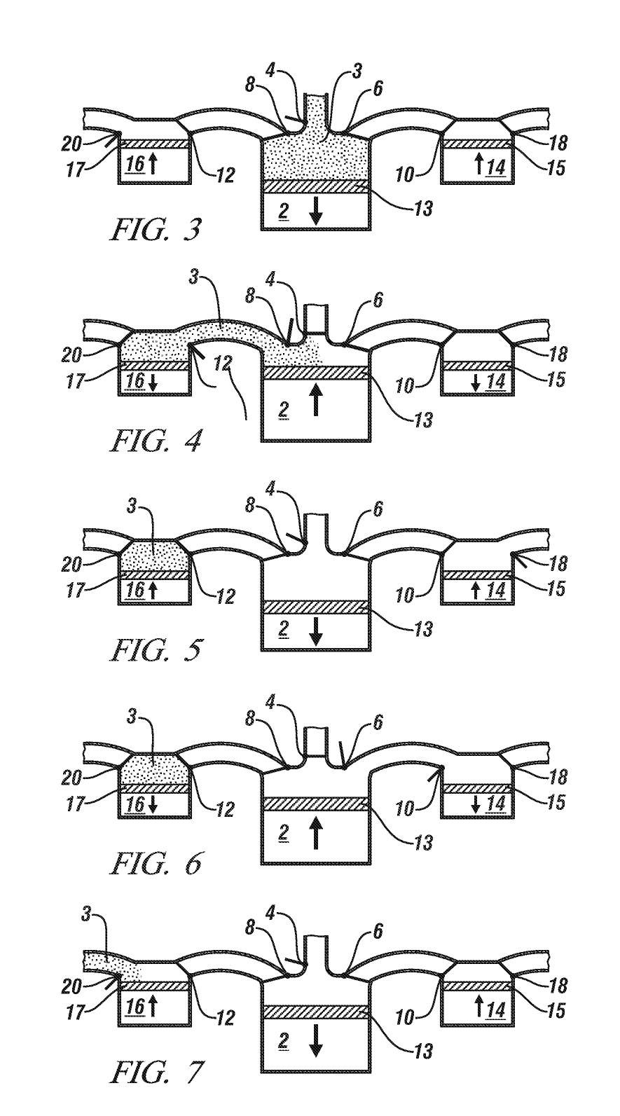

The compressor cylinder 2 may include a bore fitted with a respective reciprocating piston 13 (shown in FIGS. 3-7) operatively connected with a connecting rod to a rotating crankshaft. The compressor cylinder 2 draws in a charge via a compressor inlet 4. Specifically, the charge is received within the compressor cylinder during a first stroke of the piston 13 respective to the compressor cylinder 2 every crankshaft revolution. The charge can include one of intake air and a combination of intake air and external exhaust gas recirculation (external EGR). In alternative embodiments, the charge can further include an air-fuel mixture if the engine is a carbureted engine. The charge is received within the compressor cylinder 2 at a first pressure which is typically ambient pressure. In an alternative embodiment, the first pressure may be any provided pressure above ambient pressure. The compressor cylinder 2 additionally includes a pair of compressor outlets 6,8 through which the charge present within the compressor cylinder 2 is transferred from the compressor cylinder 2 at a second pressure. The pair of compressor cylinder outlets 6,8 can be referred to as a compressor cylinder first outlet 6 respective to the first power cylinder 14, and a compressor cylinder second outlet 8 respective to the second power cylinder 16. The compressor cylinder 2 provides a first stage of compression to the charge when the charge is transferred from the compressor cylinder 2 during every revolution of the crankshaft.

In an exemplary embodiment, the compressor cylinder 2 is a two-stroke compressor cylinder where one intake stroke (first stroke) and one compression stroke (second stroke) occurs during every revolution of the crankshaft. In other words, after the charge is received within the compressor cylinder 2 during the first stroke, the charge within the compressor cylinder is transferred to alternating ones of the first and second power cylinders 14,16, respectively, during a second stroke of the piston 13 respective to the compressor cylinder 2 every crankshaft revolution. Accordingly, the compressor cylinder 2 can include a respective valve located at the compressor cylinder inlet 4 and selectively activated between an open position for receiving the charge during the first stroke and a closed position for transferring the charge during the second stroke. The transferring provides a first compression (first stage of compression) to the charge. The first compression to the charge is realized through the compressor cylinder 2 having a larger volume than each of the first and second power cylinders 14,16, respectively. The first stroke of the piston 13 respective to the compressor cylinder includes movement in a direction towards bottom dead center of the compressor cylinder 2. Likewise, the second stroke of the piston 13 respective to the compressor cylinder includes movement in a direction toward top dead center of the compressor cylinder 2.

The first power cylinder 14 includes an inlet 10 (first power cylinder inlet) in fluid communication with the compressor cylinder first outlet 6, an outlet 18 (first power cylinder outlet) and a respective piston 15 (shown in FIGS. 3-7) slideably movable within the first power cylinder 14 and operatively connected to the rotating crankshaft. The first power cylinder 14 undergoes a second stage of compression and firing (ignition) of the charge within the first power cylinder 14 every two revolutions of the crankshaft. The second power cylinder 16 includes an inlet 12 (second power cylinder inlet) in fluid communication with the compressor cylinder second outlet 8, an outlet 20 (second power cylinder outlet) and a respective piston 17 (shown in FIGS. 3-7) slideably movable within the second power cylinder 16 and operatively connected to the rotating crankshaft. The second power cylinder 16 undergoes a second stage of compression and firing (ignition) of the charge within the second power cylinder 16 once every two revolutions of the crankshaft. In an exemplary embodiment, the second stage of compression and the firing (ignition) of the charge within the first power cylinder 14 occurs during every other revolution of the crankshaft than the second stage of compression and the firing of the charge within the second power cylinder 16. Each of the power cylinder outlets 18, 20 can include a valve selectively activated between a closed position and an open position for alternately expelling exhaust gas from the first and second power cylinders 14,16, respectively, during an exhaust stroke every two revolutions of the crankshaft. Upon being expelled from each of the power cylinder outlets 18,20 the engine exhaust gases are either vented directly to the atmosphere or are routed to an exhaust gas aftertreatment system that can include, but is not limited to, oxidation and reduction catalysts. Explained in further detail below with reference to FIG. 2, a portion of the engine exhaust gases can be recirculated through an external exhaust gas recirculation (EGR) system 150 and utilized as a portion of a charge in a subsequent engine cycle.

In an exemplary embodiment of the present disclosure, the pistons 15, 17 respective to each of the first and second power cylinders 14,16, respectively, move in a direction opposite to the direction of movement of the piston 13 respective to the compressor cylinder 2. Thus, the pistons of the power cylinders move in phase opposition to the piston of the compressor cylinder. Such phase opposition movement may be absolute thus encompassing the entire rotation of the crankshaft or may be offset by some predetermined angle wherein top dead and bottom dead center crankshaft angle position of the piston of compressor cylinder may be advanced or retarded with respect to the top dead and bottom dead center crankshaft angle position of the pistons of the power cylinders. Such offsets can, for example, provide varying degrees of effective compression ratios of the charge and account for intake flow dynamics and various intake runner geometries. Generally, however, it is envisioned that movement of the piston of compressor cylinder is substantially in phase opposition to the movement of the pistons of the power cylinders. As used herein, substantially in phase opposition includes such offset angles. Preferably, such an offset angle is less than about +/−90 degrees of crankshaft rotation. More preferably, such an offset angle is less than about +/−45 degrees of crankshaft rotation. More preferably, such an offset angle is less than about +/−22.5 degrees of crankshaft rotation.

A first port 9 is disposed between the compressor cylinder first outlet 6 and the first power cylinder inlet 10. Each of the compressor cylinder first outlet 6 and the first power cylinder inlet 10 having valves selectively activated between open and closed positions providing valve timing sufficient for selectively providing fluid communication between the compressor cylinder 2 and the first power cylinder 14 via the first port 9. Similarly, a second port 11 is disposed between the compressor cylinder second outlet 8 and the second power cylinder inlet 12. Each of the compressor cylinder second outlet 8 and the second power cylinder inlet 12 having valves selectively activated between open and closed positions providing valve timing sufficient for selectively providing fluid communication between the compressor cylinder 2 and the second power cylinder 16 via the second port 11.

As aforementioned, each of the valves variously corresponding to respective ones of the inlets and outlets of the compressor cylinder 2 and the first and second power cylinders 14,16, respectively, can be selectively activated between open and closed positions providing valve timing sufficient to enable two-stroke operation of the compressor cylinder 2 and four-stroke operation in each of the power cylinders 14,16, respectively. The two-stroke operation of the compressor cylinder 2 includes receiving the charge within the compressor cylinder 2 during the first stroke of the piston respective to the compressor cylinder 2 and transferring the charge within the compressor cylinder 2 to alternating ones of the first and second power cylinders 14,16, respectively, during the second stroke of the piston 13 respective to the compressor cylinder 2 providing the first stage of compression to the charge every crankshaft revolution. The four-stroke operation in each of the first and second power cylinders 14,16, respectively, provides the second stage of compression to the charge within alternating ones of the first and second power cylinders 14,16, respectively, every two crankshaft revolutions.

Referring to FIG. 2, a schematic representation of an engine 101 is illustrated in accordance to the present disclosure. The engine 101 is a three-cylinder internal combustion engine including a two-stroke compressor cylinder 200 and a pair of four-stroke power cylinders 140,160. The operation and functionality of the compressor cylinder 200 and each of the pair of four-stroke power cylinders 140,160 is identical to the compressor cylinder 2 and the pair of power cylinders 14,16 discussed above with reference to FIG. 1. The engine 101 illustrated in FIG. 2 further illustrates an external EGR system 150 including first and second short route EGR ports 351,251, respectively, for providing external EGR to the first and second power cylinders 140,160, respectively; and first and second long route EGR ports 352,252, respectively, for providing external EGR to the inlet 400 of the compressor cylinder 200. The EGR system 150 provides exhaust gas from each of the power cylinders 140,160 that can be recirculated to the short route EGR ports 351,251 and the long route EGR ports 352,252. The long route EGR ports 352,252 are utilized when a charge received or drawn by the compressor cylinder 200 includes a combination of intake air and external EGR. The first and second long route EGR ports 352,252 can include first and second long route outlet valves 152,154, respectively, for controlling an amount of recirculated external EGR making up the charge and entering the inlet 400 from the first and second power cylinders 140,160, respectively. The first and second short route EGR ports 351,251, respectively, can include first and second short route outlet valves 355,255, respectively, for controlling an amount of recirculated EGR entering the first and second power cylinders 140,160, respectively, via first and second power cylinder inlets 142,162, respectively. It will be understood that the external EGR system 150 can be coupled to respective outlets 180,210 of each of the first and second power cylinders 140,160, respectively, or the external EGR system 150 can be coupled to only one of the respective outlets 180,210.

In an exemplary embodiment, the first and second long route EGR ports 352,252, respectively, can be fluidly coupled to respective ones of first and second long route EGR heat exchangers 196,116, respectively, disposed upstream of respective first and second long route outlet valves 152,154, respectively. In one embodiment, at least one first and/or second long route EGR heat exchanger 196 and/or 116, respectively, can be utilized to cool the recirculated external EGR entering the inlet 400 of the compressor cylinder 200 during high load operation. In another embodiment, at least one first and/or second long route EGR heat exchanger 196 and/or 116, respectively, can be utilized to heat the recirculated external EGR entering the inlet 400 of the compressor cylinder 200 during low load operation. In an alternative embodiment, at least one first and/or second long route EGR heat exchanger bypass port 151 and/or 153, respectively, can be utilized to bypass at least one respective first and/or second long route EGR heat exchanger 196 and/or 116, respectively, when the long route EGR heat exchangers 196,116 are utilized to cool the recirculated EGR. For instance, the long route EGR heat exchanger bypass ports 151,153 by pass the respective long route EGR heat exchangers 196,116 so that the recirculated EGR is not cooled during operation at low load, and hence, provide heat to the charge entering the inlet 400 of the compressor cylinder 200.

In an exemplary embodiment of the present disclosure, the engine 101 can further include at least one first and second compressed charge heat exchanger 195 and/or 115, respectively, disposed between the compressor cylinder 200 and at least one of the first and second power cylinders 140 and/or 160, respectively. Specifically, a first port 190 providing fluid communication between the compressor cylinder 200 and the first power cylinder 140 when a first compressor outlet 204 and the first power cylinder inlet 142 are selectively in open positions, can be coupled to the first compressed charge heat exchanger 195. Likewise, a second port 110, providing fluid communication between the compressor cylinder 200 and the second power cylinder 160 when a second compressor outlet 206 and the second power cylinder inlet 162 are selectively in open positions, can be coupled to the second compressed charge heat exchanger 115. The compressed charge heat exchangers 195,115 can provide at least one of heating and cooling to the transferred charge within respective ones of the first and second ports 190,110 subsequent to a first compression and preceding a second compression to the charge. In one embodiment, the compressed charge heat exchangers 195,115 can be utilized to provide heating to the transferred charge during low load operation within respective power cylinders 140,160, respectively. In another embodiment, the heat exchanger can be utilized to provide cooling to the transferred charge during high load operation. For instance, the compressed charge heat exchanger can provide cooling to prevent autoignition when the power cylinders are operating in at least one of spark-ignition, spark-assisted homogenous charge compression ignition (HCCI) and spark-assisted premixed charge compression ignition (PCCI) modes. The cooling of the transferred charge can be utilized to increase the density of the transferred charge into at least one of the first and second power cylinders 140,160, respectively. In an alternative embodiment, each port 190,110 can include a compressed charge heat exchanger bypass port 191,111, respectively. The first and second compressed charge heat exchanger bypass ports 191,111, respectively, bypass the respective compressed charge heat exchangers 195,115, respectively, when the compressed charge heat exchangers 195,115 are utilized to cool the transferred charge. For instance, the compressed charge heat exchanger bypass ports 191,111 bypass the respective compressed charge heat exchangers 195,115, respectively, so that the transferred charge is not cooled during operation at low load in each of the respective power cylinders 140,160.

In an exemplary embodiment of the present disclosure, first and second short route EGR ports 351,251, respectively, can be fluidly coupled to respective ones of first and second short route EGR heat exchangers 197,117, respectively, disposed upstream of respective first and second short route outlet valves 355,255, respectively. In one embodiment, at least one first and/or second short route EGR heat exchanger 197 and/or 117, respectively, can be utilized to cool the recirculated external EGR entering respective ones of the first and second power cylinders 140,160, respectively, during high load operation. In another embodiment, at least one first and/or second short route EGR heat exchanger 197,117, respectively, can be utilized to heat the recirculated external EGR entering respective ones of the first and second power cylinders 140,160, respectively, during low load operation. In an alternative embodiment, at least one first and/or second short route EGR heat exchanger bypass port 123 and/or 121, respectively, can be utilized to bypass at least one respective first and/or second short route EGR heat exchanger 197 and/or 117, respectively, when the short route EGR heat exchangers 197,117 are utilized to cool the recirculated EGR. For instance, the short route EGR heat exchanger bypass ports 123,121 bypass the respective short route EGR heat exchangers 197,117 so that the recirculated EGR is not cooled during operation at low load, and hence, provide heat to the charge entering the power cylinders 140,160. In an alternative embodiment, the compressed charge heat exchangers 195,115 can utilize the heat from the external EGR recirculated via respective short route EGR ports 351,251.

FIGS. 3-7 show relative motion and position of pistons and valves in an engine during various states of operation in accordance with an exemplary embodiment of the present disclosure. During an intake stroke shown in FIG. 3, air (charge 3) is drawn into the compressor cylinder 2 when the piston 13 in the compressor cylinder 2 is traveling downwards in its cylinder bore while the compressor inlet 4 is opened and both of the first and second outlets 6,8, respectively, are closed. The first power cylinder 14 is undergoing the second compression (second stage of compression), further explained below, where its piston 15 is travelling upwards and its inlet and outlet 10,18 being closed. The second power cylinder 16 is undergoing an exhaust stroke, further explained below, where its piston 17 is travelling upwards, its inlet 12 being closed and its outlet 20 being open.

During the first compression (first stage of compression) illustrated in FIG. 4, the inlet 4 of the compressor cylinder is closed, the first outlet 6 is closed and the second outlet 8 is open, allowing the charge 3 present in the compressor cylinder 2 to be forced (transferred) into the second power cylinder 16 through the open inlet 12 of the second power cylinder 16, wherein the outlet 20 of the second power cylinder 16 is closed. As such, the second power cylinder 16 is undergoing an intake stroke with its piston 17 travelling downward in its cylinder bore. The transferred charge 3 into the second power cylinder 16 will be at a pressure that is higher in magnitude than atmospheric realized through the compressor cylinder 2 having a larger volume than each of the power cylinders 14,16. Simultaneously, a heat exchanger, such as the second compression charge heat exchanger 115 illustrated in FIG. 2, can be utilized to provide at least one of heating and cooling to the transferred charge between the compressor cylinder 2 and the second power cylinder 16. For instance, the second compression charge heat exchanger 115 can be utilized to cool the transferred charge during high load operation or the second compression charge heat exchanger 115 can be utilized to heat the transferred charge during low load operation. Concurrently, the first power cylinder 14 is undergoing a power stroke, explained in further detail below, where both its inlet and outlet 10,18, respectively, are closed and its piston 15 is travelling downward.

During the second compression of the charge shown in FIG. 5, the inlet and outlet 12,20, respectively, of the second power cylinder 16 are both closed and the piston 17 travels upwards in its bore to achieve the second compression (second stage of compression) to the contained charge prior to ignition. Simultaneously, a heat exchanger, such as the second compression charge heat exchanger 115 illustrated in FIG. 2, can be utilized to provide at least one of heating and cooling to portions of the charge trapped between the compressor cylinder 2 and the second power cylinder 16. The ignition can include compression ignition including HCCI, PCCI and conventional compression ignition as used in diesel engines. The ignition can further include a spark-ignition or spark-assisted HCCI and PCCI ignitions. The first compressor cylinder 2 is undergoing another intake stroke with its inlet 4 open and the first and second outlets 6,8, respectively, are closed while the piston 13 is travelling downward. The first power cylinder 14 is undergoing an exhaust stroke with its respective inlet 10 closed, the respective outlet 18 open to expel exhaust gas while the piston 15 is travelling upwards. One will appreciate that one crankshaft revolution has elapsed between the intake stroke in the compressor cylinder 2 and the second compression in the second power cylinder 16 illustrated in FIGS. 3 and 5, respectively. In other words, during the expelling exhaust gas from the first power cylinder 14 and the providing the second compression to the charge within the second power cylinder 16, the first and second power cylinder inlets 10,12, respectively, and the second power cylinder outlet 20 are selectively closed. The first power cylinder outlet 18 is selectively opened to expel the exhaust gas from the first power cylinder 14 and the second power cylinder outlet 20 is selectively closed to provide the second compression to the charge.

During the power (expansion) stroke shown in FIG. 6, the gases produced as a result of the ignition and combustion of the charge in the second power cylinder 16 force the piston 17 in the second power cylinder 16 downward, the inlet and outlet 12, 20, respectively, are closed. Simultaneously, the compressor cylinder 2 is undergoing another compression stroke (first compression) with the inlet and second outlet 4,8 closed and the first outlet 6 open. Concurrently, the first power cylinder 14 is undergoing an intake stroke with the inlet valve 10 open, the outlet valve 18 closed while the piston is travelling downward. Hence, the compressor cylinder 2 is transferring the charge to alternating ones of the first and second power cylinders 14,16, respectively, during a second stroke of the piston 13 respective to the compressor cylinder 2 every crankshaft revolution. The second compression is provided to the charge within alternating ones of the first and second power cylinders 14,16, respectively, every crankshaft revolution during the intake stroke (intake stroke) of the compressor cylinder 2, where the second compression and ignition of the charge occur once every two crankshaft revolutions in each of the first and second power cylinders 14,16, respectively. Here, the compressor inlet 4 is always closed and one of the first and second compressor cylinder outlets 18,20, respectively, is open and the other one of the first and second compressor cylinder outlets 18, 20, respectively, is selectively closed corresponding to the alternated one of the first and second power cylinders 14,16, respectively, receiving the transferred charge from the compressor cylinder 2.

During the exhaust stroke shown in FIG. 7, the combusted and expanded gas present in the second power cylinder 16 is expelled through the open outlet 20 of the second power cylinder 16 due to the piston 17 travelling upward, enabling expulsion of the combusted and expanded gas from the engine. The inlet 12 of the second power cylinder 16 is closed during the exhaust stroke. The exhaust gas from the second power cylinder 16 can be vented directly to the atmosphere or can be routed to an exhaust gas aftertreatment system that includes, but is not limited to, oxidation and reduction catalysts. Further, a portion of the exhaust gas from the second power cylinder 16 can be routed to an EGR system (EGR system 150 shown in FIG. 2) that can include a long route EGR port (second long route EGR ports 252) and short route EGR port (second short route EGR port 251). The long route EGR port can recirculate exhaust gas from the second power cylinder 16 back to the inlet 4 of the compressor cylinder when a charge received or drawn by the compressor cylinder 2 includes a combination of intake air and external EGR. The short route EGR port can recirculate exhaust gas from the second power cylinder 16 back to the inlet 12 of the second power cylinder 16. The configuration of the crankshaft and the pistons and valves for each of the cylinders is identical to that of the compressor intake stroke described above with reference to FIG. 3A.

It is understood that while FIGS. 3-7 illustrate engine operation of receiving a charge within the compressor cylinder 2 through 4-stroke operation of the second power cylinder 16, the motion and position of the piston 15, inlet 10 and outlet 18 through 4-stroke operation of the first power cylinder 14 is identical during a subsequent crankshaft revolution. In other words, when the first power cylinder 14 includes one of a second compression and an exhaust stroke, the second power cylinder 16 includes the other one of a second compression stroke and an exhaust stroke. Likewise, when the first power cylinder 14 includes one of a power stroke and an intake stroke, the second power cylinder 16 includes the other one of a power stoke and an intake stroke.

A control module can be utilized to control the operation of the pistons and selective closing and opening of the valves through 2-stroke operation of the compressor cylinder 2 and 4-stroke operation in each of the first and second power cylinders 14,16, respectively.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller executable instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An internal combustion engine, comprising:
a compressor cylinder having a respective inlet, a first outlet and a respective piston slideably movable within the compressor cylinder and operatively connected to a rotating crankshaft, the compressor cylinder providing a first stage of compression to a charge when the charge is transferred from the compressor cylinder during every revolution of the crankshaft; and
a first power cylinder having a respective inlet in fluid communication with the first outlet of the compressor cylinder, a respective outlet and a respective piston slideably movable within the first power cylinder and operatively connected to the rotating crankshaft, the first power cylinder providing a second stage of compression and firing of the charge within the first power cylinder every two revolutions of the crankshaft.

2. The internal combustion engine of claim 1 further comprising:
the compressor cylinder further comprising a second outlet; and
a second power cylinder having a respective inlet in fluid communication with the second outlet of the compressor cylinder, a respective outlet and a respective piston slideably movable within the second power cylinder and operatively connected to the rotating crankshaft, the second power cylinder providing a second stage of compression and firing of the charge within the second power cylinder every two revolutions of the crankshaft.

3. The internal combustion engine of claim 2 further comprising:
an external exhaust gas recirculation system coupled to the outlet of one of the first and second power cylinders and comprising at least one of
a short route port providing an exhaust gas path from said one of the first and second power cylinders back to the corresponding inlet of said one of the first and second power cylinders, and
a long route port for providing an exhaust gas path from said one of the first and second power cylinders to the inlet of the compressor cylinder.

4. The internal combustion engine of claim 3 further comprising at least one of:
a short route heat exchanger fluidly coupled to said short route port, said short route heat exchanger providing at least one of heating and cooling to the exhaust gas entering the corresponding power cylinder;
a long route heat exchanger fluidly coupled to said long route port, said long route heat exchanger providing at least one of heating and cooling to the exhaust gas entering the inlet of the compressor cylinder; and
a compressed charge heat exchanger disposed between one of the first and second outlets of the compressor cylinder and the inlet of the corresponding one of the first and second power cylinders, said compressed charge heat exchanger providing at least one of heating and cooling to the charge transferred from the compressor cylinder.

5. The internal combustion engine of claim 2 wherein the compressor cylinder comprises a larger volume than each of the first and second power cylinders.

6. The internal combustion engine of claim 2 further comprising
a plurality of valves, each of the valves corresponding to a respective one of the compressor inlet, the first and second compressor cylinder outlets, the inlets and the outlets of the first and second power cylinders, the plurality of valves selectively activated between open and closed positions providing valve timing sufficient to enable two-stroke operation of the compressor cylinder and four-stroke operation of the power cylinders.

7. The internal combustion engine of claim 6 wherein the two-stroke operation of the compressor cylinder comprises receiving the charge within the compressor cylinder during a first stroke of the piston respective to the compressor cylinder and transferring the charge within the compressor cylinder to alternating ones of the first and second power cylinders during a second stroke of the piston respective to the compressor cylinder thus providing the first stage of compression to the charge every crankshaft revolution, and wherein the four-stroke operation in each of the first and second power cylinders provides the second stage of compression to the charge within alternating ones of the first and second power cylinders every two revolutions of the crankshaft, the second stage of compression and the firing of the charge within each of the first and second power cylinders occurring during alternate revolutions of the crankshaft.

8. The internal combustion engine of claim 1 wherein the compressor cylinder draws in the charge via the inlet of the compressor cylinder and said charge comprises one of intake air and a combination of intake air and externally recirculated exhaust gas.

9. Method of operating an internal combustion engine comprising a compressor cylinder and first and second power cylinders, each of the power cylinders in fluid communication with the compressor cylinder, each of the compressor cylinder and the first and second power cylinders including a respective piston rotatably coupled to a common crankshaft, the method comprising:
receiving a charge within the compressor cylinder during a first stroke of the piston respective to the compressor cylinder every crankshaft revolution;
transferring the charge within the compressor cylinder to alternating ones of the first and second power cylinders during a second stroke of the piston respective to the compressor cylinder every crankshaft revolution, said transferring providing a first compression of the charge; and
providing a second compression and an ignition of the charge within the one of the first and second power cylinders having received the charge, the second compression and ignition of the charge occurring once every two crankshaft revolutions in each of the first and second power cylinders.

10. The method of claim 9, wherein the first stroke of the piston respective to the compressor cylinder comprises movement in a direction towards bottom dead center and the second stroke of the piston respective to the compressor cylinder comprises movement in a direction toward top dead center.

11. The method of claim 9, wherein the pistons respective to each of the first and second power cylinders comprise movement in substantial phase opposition to movement of the piston respective to the compressor cylinder.

12. The method of claim 9 wherein said transferring providing the first compression to the charge comprises the first compression of the charge realized through the compressor cylinder having a larger volume than each of the first and second power cylinders.

13. The method of claim 9, further comprising:
externally recirculating exhaust gases from a respective outlet of at least one of said first and second power cylinders to a respective inlet of said at least one of said first and second power cylinders.

14. The method of claim 9, further comprising:
externally recirculating exhaust gases from a respective outlet of at least one of said first and second power cylinders to a respective inlet of said compressor cylinder.

15. The method of claim 9 further comprising providing a heat exchange with the charge during its transfer to alternating ones of the first and second power cylinders.

16. The method of claim 15 wherein said heat exchange with the charge comprises transferring heat to the charge from exhaust gases from at least one of said first and second power cylinders during a low load engine operation.

17. The method of claim 15 wherein said heat exchange with the charge comprises transferring heat from the charge during a high load engine operation.

18. An internal combustion engine, comprising:
a crankshaft;
a compressor cylinder having a respective inlet, first and second outlets, and a respective piston slideably movable within the compressor cylinder and operatively connected to the crankshaft, the compressor cylinder providing a first stage of compression to a charge when the charge is transferred from the compressor cylinder during every revolution of the crankshaft;
a first power cylinder having a respective volume smaller than the volume of the compressor cylinder, a respective inlet in fluid communication with the first outlet of the compressor cylinder, a respective outlet and a respective piston slideably movable within the first power cylinder and operatively connected to the crankshaft, the first power cylinder providing a second stage of compression of the charge within the first power cylinder every two revolutions of the crankshaft;
a second power cylinder having a respective volume smaller than the volume of the compressor cylinder, a respective inlet in fluid communication with the second outlet of the compressor cylinder, a respective outlet and a respective piston slideably movable within the second power cylinder and operatively connected to the crankshaft, the second power cylinder providing a second stage of compression of the charge within the second power cylinder every two revolutions of the crankshaft;
an external exhaust gas recirculation system coupled to the outlet of one of the first and second power cylinders and comprising at least one of
a short route port providing an exhaust gas path from said one of the first and second power cylinders back to the corresponding inlet of said one of the first and second power cylinders, and
a long route port for providing an exhaust gas path from said one of the first and second power cylinders to the inlet of the compressor cylinder;
a short route heat exchanger fluidly coupled to said short route port, said short route heat exchanger providing at least one of heating and cooling to the exhaust gas entering the corresponding power cylinder;
a long route heat exchanger fluidly coupled to said long route port, said long route heat exchanger providing at least one of heating and cooling to the exhaust gas entering the inlet of the compressor cylinder; and
a compressed charge heat exchanger disposed between one of the first and second outlets of the compressor cylinder and the inlet of the corresponding one of the first and second power cylinders, said compressed charge heat exchanger providing at least one of heating and cooling to the charge transferred from the compressor cylinder.
